(19) United States
(12) Patent Application Publication
(10) Pub. No.: US 2014/0252807 A1
(43) Pub. Date: Sep. 11, 2014

(54) TOP & BOTTOM CHANNEL ASSEMBLY SECTION FOR VEHICLE FRAME AND METHOD OF MAKING THE SAME

(71) Applicant: Metalsa S.A. de C.V, Monterrey, N.L. (MX)

(72) Inventors: Noemi Caballero Medina, Nuevo Leon (MX); Francisco Javier Gonzalez, Roanoke, VA (US); Oscar Adrian Sanchez Leal, Nuevo Leon (MX); Francisco Javier Pacheco Tiscareno, San Luis Potosi (MX)

(73) Assignee: Metalsa S.A. de C.V, Monterrey, N.L. (MX)

(21) Appl. No.: 14/199,182

(22) Filed: Mar. 6, 2014

Related U.S. Application Data
(60) Provisional application No. 61/774,023, filed on Mar. 7, 2013.

(51) Int. Cl. B62D 21/00; B62D 65/00

(52) U.S. Cl. CPC B62D 21/00; B62D 65/00
USPC 296/204; 29/897.2

(57) ABSTRACT

A heavy truck frame (18) and a method for manufacturing a heavy truck frame having side-rails (20, 24) with a configuration of a top C-section (30) and a bottom C-section (32) and a vertical insert (34) so as to reduce weight and maintain the stiffness requirements and improve payload. The optimal distances between a top C-section (30) and a bottom C-section (32) can vary according to the part of the frame and vehicle requirements.

### CROSS-REFERENCE TO RELATED APPLICATION

This application claims priority to and all benefits of U.S. Provisional Application 61/774,023, filed on Mar. 7, 2013, entitled “Top & Bottom Channel Assembly Section for Vehicle Frame and Method of Making the Same”, which is incorporated herein by reference.

### FIELD OF THE DISCLOSURE

The disclosure broadly relates to designing and manufacturing frames for vehicle chassis and is particularly useful for the manufacture of frames with C-sections and inserts for heavy trucks for providing significant weight savings and vehicle efficiency benefits.

### BACKGROUND OF THE DISCLOSURE

The description will be mainly in terms of its applicability to heavy truck chassis-frame (typically ladder frames). There is a constant push to increase the energy efficiency of vehicles, which results in the desire to utilize a minimum amount of materials by switching to lighter materials and more efficient designs, yet essentially maintaining the vehicle's desired characteristics, such as its stiffness and improved payload.

In recent years for the manufacturing of frames, particularly for automotive applications, several designs and materials have been made available among which we can list lighter-weight composite ladder frames and segmented frames, all of them deriving in an increase of product cost with not enough weight reduction benefit.

Therefore, there is a great emphasis on weight reduction materials and designs in all vehicle components.

These continuing concerns and prior attempts to get practical solutions are discussed in prior publications, such as U.S. Pat. No. 8,485,555, which specifies the need for a vehicle frame designed accordingly to the different loads and service demands that are required for different areas of the frame.

It is therefore desirable to consider the optimization of the frame configuration to achieve as much as 40% in weight reduction while maintaining the industry requirements, such as payload and stiffness.

### OBJECTS AND SUMMARY OF THE DISCLOSURE

The present disclosure overcomes the drawbacks of the current art by introducing a heavy truck frame designed for segmented requirements of the vehicle and providing significant weight reductions while improving the frame characteristics.

The present disclosure is directed to provide weight reduction in the main frame members of heavy duty trucks by placing two frame rails C-sections facing each other as shown in FIG. 4 to serve as top and bottom flanges and connect them by a vertical insert. The top and bottom C-sections may vary in height depending on stiffness required.

In a preferred embodiment, top and bottom C-sections are independently separated components connected by an insert. It is to be understood that all sections may be made from one piece while respecting the mentioned geometry.

The frame members may be made from steel, either heat treated or high strength low alloy (HSLA) steel, from non-ferrous metal such as aluminum, or may also utilize composite materials or any combination of said materials to achieve desired weight and stiffness. The connections between the members may be made by several joining methods such as bolting, riveting, welding or other fastening or bonding methods.

In the broader aspects of this disclosure, the two C-channel sections are formed using traditional methods, such as roll-forming, stamping or break press, to provide primary sectional stiffness. The vertical insert may be blanked or formed by traditional methods. Either a single insert full length or multiple inserts can be used to optimize weight and performance.

Top and bottom C-sections are placed facing their cavities toward each other and then assembled to the vertical insert to make up the side-rail assembly. Since the vertical insert is required to provide minimal vertical stiffness, it may be thinner relative to top and bottom C-sections, which provide the primary stiffness for the side-rail assembly. The vertical insert is designed, or located, in a way to optimize the height, the vertical stiffness and the material utilization. The insert may be continuous, or for weight reduction purposes, it may be made of rods or any other type of support structure that links the top and the bottom C-sections. In some instances, the vertical insert may be eliminated completely if the cross-member system is robust enough to provide the function of the insert.

In an appropriate design for a heavy truck frame, the maximum stiffness is required in the middle of the lengthwise frame, less stiffness in the rear and even less stiffness in the front. The insert height can be optimized to be most in middle, less in rear and least in front. Said optimization of the vertical insert allows for a very efficient frame rail assembly with up to 40% weight reduction while maintaining stiffness required from traditional C-channel heavy truck frame rails.

It is therefore an object of the present disclosure to provide a heavy truck frame and a method for manufacturing a heavy truck frame wherein said frame is optimized to decrease its weight up to 40% preferably by using a specific configuration of two C-sections and a vertical insert so as to maintain its stiffness requirements and improve payload respectively.

### BRIEF DESCRIPTION OF THE DRAWINGS

The above-mentioned and other features of this disclosure and the manner of obtaining them will become more apparent, and the disclosure itself will be best understood by reference to the following descriptions of assemblies and frames taken in conjunction with the accompanying figures, which are given as non-limiting examples only, in which:

FIG. 1 is a perspective view of a heavy truck frame, with traditional C-channel side-rails, according to prior art,

FIG. 2 is a sectional view of the side-rail C-section from the prior art,

FIG. 3 is a perspective view of a heavy truck frame according to one preferred embodiment of the present disclosure,

FIG. 4 shows a schematic section of the top and bottom C-sections bonded by a vertical insert for the preferred embodiment of the present disclosure,

FIG. 5 is a schematic side view of a side-rail according to the preferred embodiment of the present disclosure, and

FIG. 6 shows a schematic section of the top and bottom C-sections bonded by an alternative vertical insert.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

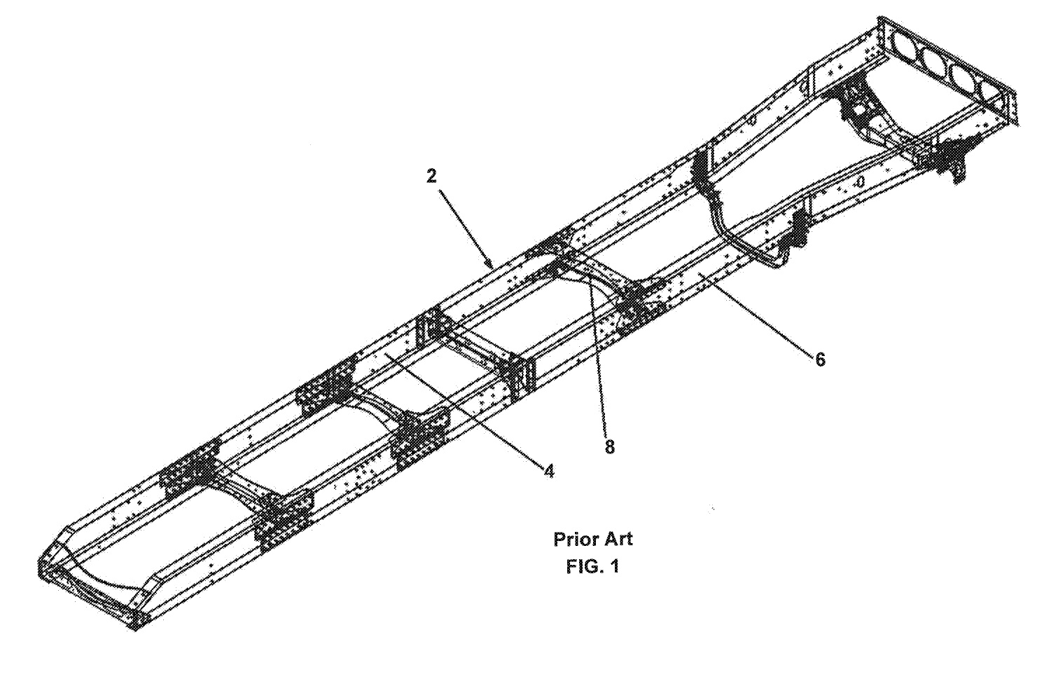

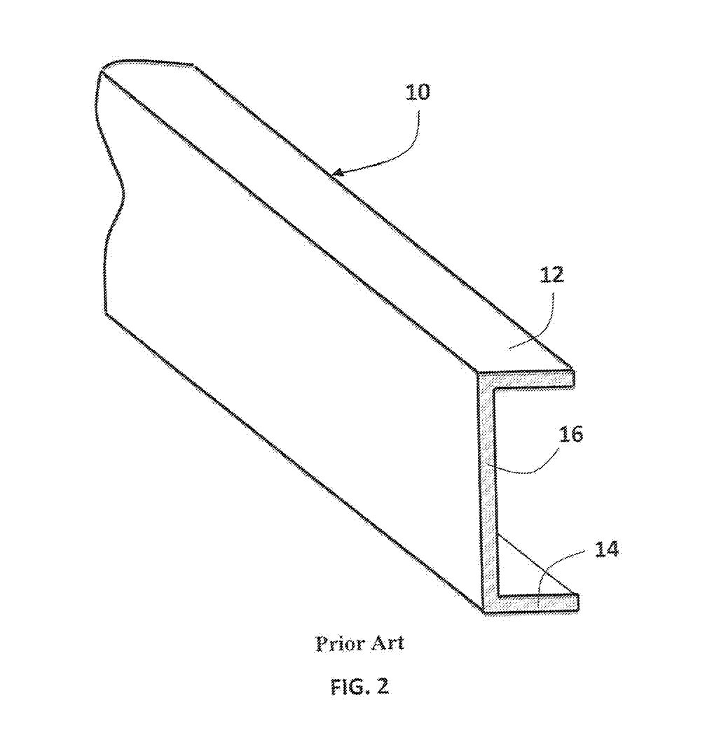

Referring to FIG. 1, a heavy truck ladder-frame (2) according to prior art is shown wherein said frame (2) is comprised a plurality of side-rails (4, 6) bonded by a serial of cross members (8). As shown in FIG. 2, each side-rail (10) can be made by a C-section, wherein the top section (12) and bottom section (14) of said C-section have usually the same thickness as the vertical section (16). Said prior art side-rail design does not optimize the frame's weight and payload demands as the present disclosure.

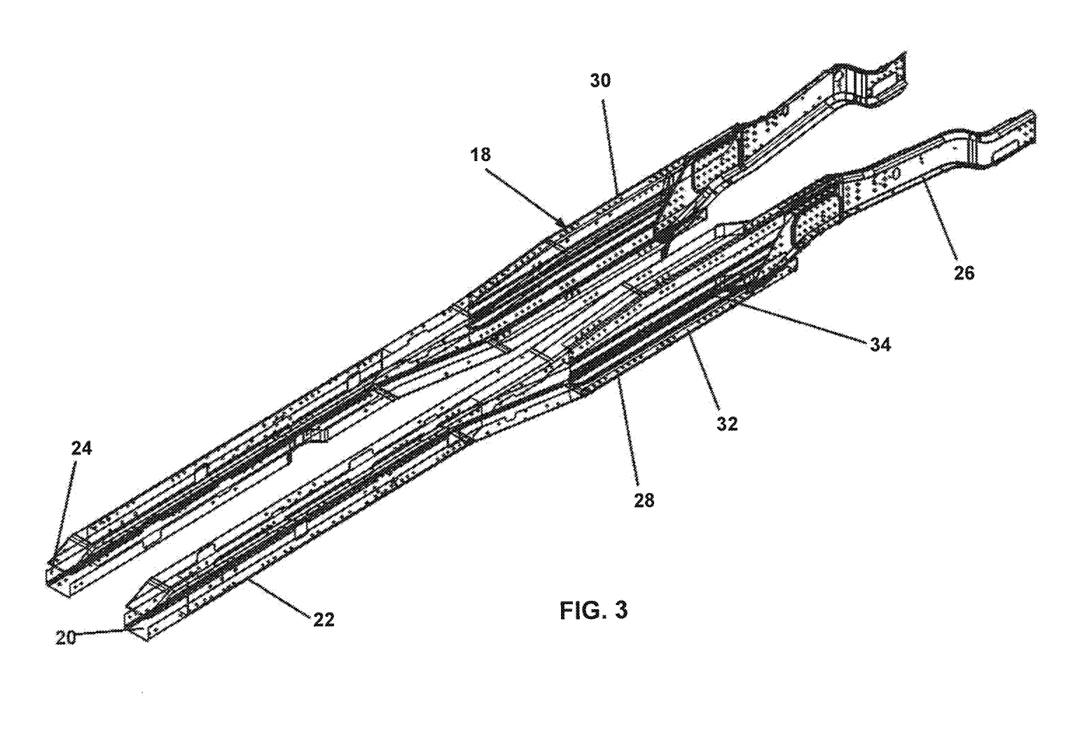

According to a preferred embodiment of the disclosure, shown in FIG. 3, the frame (18) is formed by a plurality of side-rails (20, 24), wherein each side-rail is designed accordingly to the required characteristics in its rear part (22), its front part (26) and its middle part (28). Each of the side-rails (20, 24) comprises a top C-section (30), a bottom C-section (32), and a vertical insert (34).

The design of the present disclosure is intended to be shaped according to the vehicle needs, wherein the each part of the frame (18) can adapt its top and bottom C-sections (30, 32) as its vertical insert (34) according to its requirements. The length and thickness of the bottom C-section (32), the top C-section (30), and the vertical insert (34) can be adjusted according to vehicle requirements. The insert height may be most at the middle part (28), less in the rear part (22) and possibly varying at the front part (26) to meet different vehicle requirements.

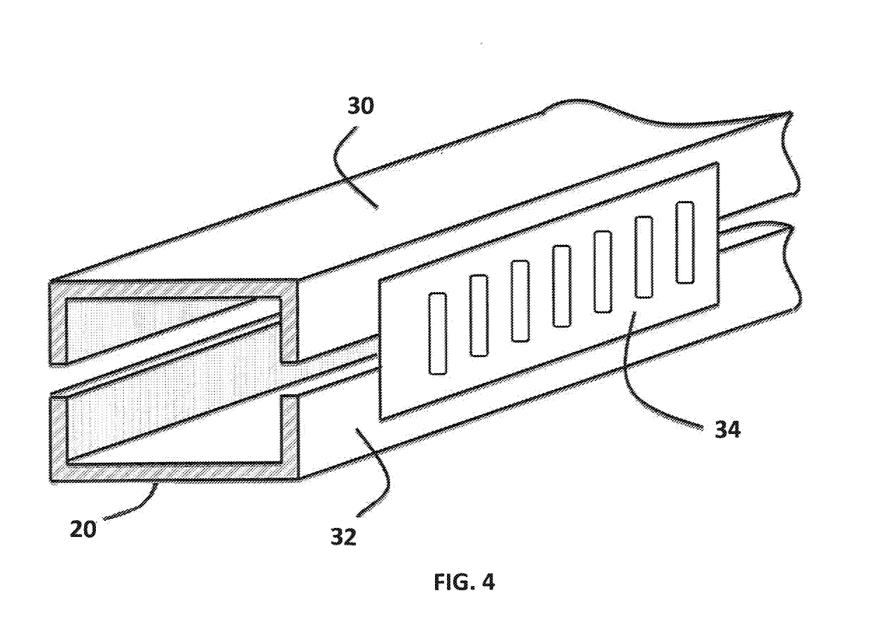

Referring to FIG. 4, a schematic view of a preferred side-rail (20) for the present disclosure is shown, wherein said side-rail (20) comprises a top C-section (30), a bottom C-section (32) and a vertical insert (34) that connects both C-sections (30 and 32). As will be understood by a skilled person in the art, the present disclosure may be formed by a single section or a plurality of sections as long as it commits to the geometry that allows optimizing the stiffness of the frame (18) in relation to the amount of material used and its proportional weight.

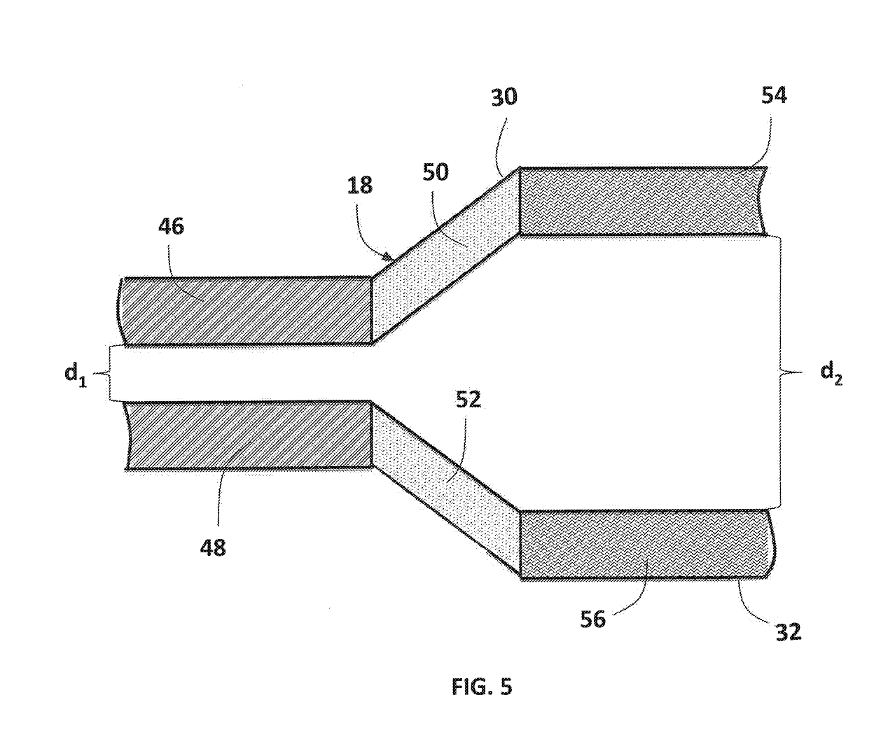

FIG. 5 shows a schematic side view part of the frame (18) from the present disclosure wherein an initial top C-section (46) and an initial bottom C-section (48) are separated according to their stiffness and payload requirements to a distance d₁ between them, where in the shorter the distance the less stiffness and payload requirements that the frame (18) needs for that specific part. Additionally, an opening top section (50) and an opening bottom section (52) are gradually separated to achieve optimal distance d₂ between top section (54) and bottom section (56) for a higher stiffness and payload requirements than the ones specified for C-sections (46 and 48).

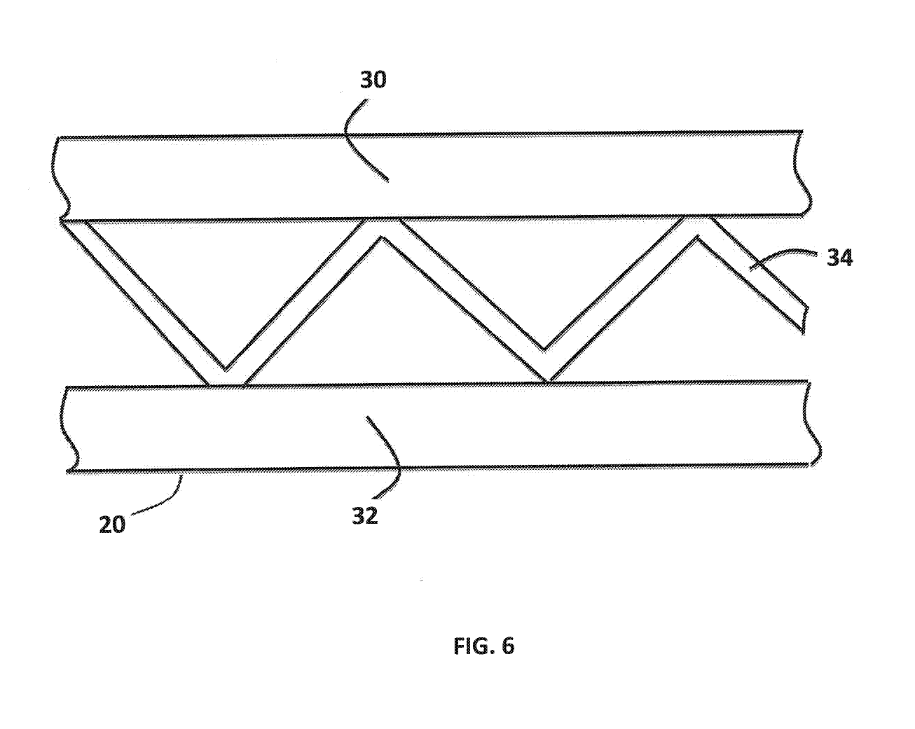

FIG. 6 is a schematic side view of a side-rail (20) from an alternative embodiment of the disclosure wherein the top C-section (30) and bottom C-section (32) are bonded or secured together by a vertical insert (34) made out of rods or other joining methods that allow the side-rail (20) to optimize the frame's weight without compromising its stiffness and payload performance.

The manufacture of heavy truck frames (18) with C-sections (30 and 32) and one or more vertical inserts (34) can provide significant weight savings and vehicle efficiency benefits.

Before configuration of two C-sections (30, 32) and a vertical insert (34), each component can be separately formed. The two C-sections (30, 32) can be formed using traditional methods, such as roll-forming, stamping or break press, to provide primary sectional stiffness. The C-sections (30, 32) may each be made as one continuous piece. The vertical insert (34) may be blanked or formed by traditional methods.

The frame members such as rails (20, 24) of heavy duty trucks can be manufactured by placing two C-sections (30 and 32) facing each other as shown in FIG. 4 to serve as top and bottom channel assembly sections (30 and 32) and the connecting them by a vertical insert (34).

Top and bottom C-sections (30 and 32) are placed facing their cavities toward each other and then assembled to the vertical insert (34) to make up the side rail assembly. Since the vertical insert (34) is required to provide minimal vertical stiffness, it may be thinner relative to top and bottom C-sections (30 and 32), which provide the primary stiffness for the side rail assembly. The vertical insert (34) is designed, or located, in a way to optimize the height, the vertical stiffness and the material utilization. The insert (34) may be continuous or for weight reduction purposes, it may be made of rods or any other type of support structure that links or connects the top and the bottom C-sections (30, 32).

Two side-rails (20 and 24) can be combined to make a frame (12).

The top and bottom C-sections (30, 32) may vary in height depending on stiffness required. In an appropriate design for a heavy truck frame (18), the maximum stiffness is required in the middle of the lengthwise frame, less stiffness in the rear and even less stiffness in the front. The insert height can be optimized to be most in middle, less in rear and possibly least in front, but the front may vary as needed per the particular frame.

1. A frame (18) adapted for a vehicle chassis comprising a plurality of side-rails (20, 24), each side-rail (20, 24) having a top C-section (30), a bottom C-section (32) and a vertical insert (34) that connects both C-sections (30, 32), wherein cavities of the top C-section (30) and the bottom C-section (32) face each other.

2. The frame of claim 1 wherein the vertical insert (34) is thinner than each C-section (30, 32).

3. The frame of clam 1 wherein each side-rail (20, 24) has a rear part (22), a front part (26) and a middle part (28) and insert height is most at the middle part (28) and is less in the rear part (22).

4. A method of manufacturing a vehicle frame (18) with side-rails (20, 24) having top and bottom C-sections (30, 32) and inserts (34) comprising the steps of
placing two C-sections (30 and 32) with their cavities facing each other;
connecting C-sections (30 and 32) with a vertical insert (34) to form a side-rail (20); and
combining two side-rails (20 and 24) to make a frame (18).

5. The method of claim 4 wherein the insert (34) is continuous.

6. The method of claim 4 wherein distances between the top and bottom C-sections (30, 32) vary in height

7. The method of claim 6 wherein the step of connecting C-sections (30 and 32) by a vertical insert (34) includes using numerous vertical inserts (34) and wherein the C-sections (30, 32) are bent and placed with a lower insert height between the C-sections (30, 32) in a rear part (22) with the less stiffness and payload requirements that the frame (18) needs for that specific part and with an insert height that is greater in a middle part (28) for the maximum stiffness in the middle of a lengthwise direction of the frame (18).
